(19) United States
(12) Patent Application Publication
(10) Pub. No.: US 2026/0310517 A1
(43) Pub. Date: Oct. 8, 2026

(54) BLOCKCHAIN-ENHANCED DATA ASSET MANAGEMENT AND DISTRIBUTED COMPUTATION PLATFORM

(71) Applicants: Khushali Mihir THAKKAR, Mumbai (IN); Mihir Dinesh THAKKAR, Mumbai (IN)

(72) Inventors: Khushali Mihir THAKKAR, Mumbai (IN); Mihir Dinesh THAKKAR, Mumbai (IN)

(73) Assignees: Khushali Mihir THAKKAR, Mumbai, MH (IN); Mihir Dinesh THAKKAR, Mumbai, MH (IN)

(21) Appl. No.: 19/483,908

(22) PCT Filed: Sep. 21, 2024
(86) PCT No.: PCT/IN2024/051814

§ 371 Date: Nov. 12, 2025

(30) Foreign Application Priority Data
Sep. 23, 2023 (IN) 202321064028

(51) Int. Cl. G06F 9/50; G06F 21/64

(52) U.S. Cl. CPC G06F 9/5044; G06F 21/64; G06Q 2220/00

(57) ABSTRACT

The present invention relates to cutting-edge blockchain-based platform addressing critical issues in data sharing and collaboration within the financial sector. Aligned with government data sharing policies, this platform fosters unfettered data sharing and collaborative endeavors across diverse sectors. This bridges the gap between Data Providers and Scientists, facilitating the convergence of data assets and analytical expertise. Smart contract infrastructure reduces operational costs and enhances efficiency. This invention offers solution for secure data asset management, collaboration, and distributed computation, benefiting financial institutions or banks as data providers, algorithm developers as data scientists and idle gaming PC's as remote nodes where job's are computed.

This application is related to Indian Patent application No. IN202321064028 filed on 23rd Sep, 2023 and is incorporated herein in its entirety.

### TECHNICAL FIELD

The present invention pertains to the field of blockchain technology and its applications in secure and distributed artificial intelligence and machine learning computations, as well as data asset management. More specifically, the present invention focuses on addressing challenges related to data sharing, collaboration, data security, and efficient resource utilization within the financial sector and other industries requiring secure and transparent data handling.

### BACKGROUND ART

In today's rapidly evolving digital landscape, data has become the lifeblood of industries, driving innovation, making informed decision-making, and competitive advantage. The demand for efficient data sharing, secure collaboration, and advanced computational capabilities has seen an exponential rise in the financial sector.

However, this surge in data-driven processes has brought to the forefront several pressing challenges.

Traditional data-sharing mechanisms often fall short in terms of security, transparency, and accountability, posing risks to sensitive information and impeding effective collaboration. Furthermore, incentivizing collaboration among diverse stakeholders, particularly in highly regulated industries like finance, has proven to be a complex endeavor. The need for innovative solutions that address these challenges and ensure data compliance with regulatory imperatives has never been more pronounced. However, despite the growing importance of data, several critical challenges have surfaced.

One major challenge lies in the suboptimal data-sharing and collaboration mechanisms employed by financial institutions and other organizations employ. These mechanisms often lack the robustness required to securely and efficiently exchange data among diverse entities. Consequently, this can limit the depth of insights that can be derived from shared data and hinder collaborative efforts aimed at solving complex problems.

Another issue is the inadequate incentivization of data sharing and collaboration. Many financial institutions may hesitate to share their data due to a lack of compelling incentives. Without proper motivation, these institutions may withhold valuable data that could otherwise lead to more accurate predictions, enhanced risk management, and improved decision-making.

Additionally, a significant reservoir of high-value datasets remains underutilized due to the absence of a widely adopted and secure platform for AI-ML computations. These datasets hold the potential to unlock valuable business insights, reduce risks, and create growth opportunities. However, the challenges associated with securely sharing these datasets while complying with stringent legal requirements have limited their ex-ploitation.

Furthermore, technological advancements have led to abundant powerful hardware in individuals' homes that often sits idle during non-working hours. Leveraging this idle hardware for AI-ML computations represents an untapped resource that can contribute to distributed computing networks while providing opportunities for users to earn rewards.

Lastly, independent data scientists possess the expertise to create high-performance Machine Learning and Deep Learning models catered to a specialized use case, but in reality, they often lack incentives to contribute to the financial sector. Encouraging their active participation and collaboration can lead to the development of more sophisticated algorithms and predictive models.

The present invention introduces a pioneering blockchain-based platform to address these challenges and unlock powerful insights that would otherwise remain untapped. This platform integrates cutting-edge technologies such as blockchain, Smart contracts, Non-Fungible Tokens (NFTs), and the contribution of Remote Node providers to revolutionize data asset management, collaborative AI-ML computations, and valuable business insights. The vision of the present invention aligns with government initiatives promoting transparent and accountable data sharing while fostering community-driven collaboration. By using untapped resources in the form of powerful CPUs/GPUs, and ensuring robust security and compliance, this invention seeks to usher in a new era of data-driven decision-making across diverse sectors, focusing on the financial industry.

The present invention comprehensively explores the novel approach to leverage the power of ML/DL based state-of-the-art algorithms in answering real-world problems in the BFSI (Banking, Financial Services & Insurance) Industry. Through a blend of technology and visionary thinking, the invention addresses the pressing challenges of our data-rich world, ushering in a new era of secure, transparent, and collaborative data management and computation.

The present invention (Ostrich Platform) takes transactional as well as static data from the banks which they classify into Critical Personal Data, Sensitive Personal Data and General Personal Data, which along-with a ML/DL Algorithm (Machine learning/Deep learning) possess the capacity to generate actionable outputs from the data in terms of predicting various different data points for the Financial Institution/Client.

The present invention is connecting the ideal remote hardware directly to the present system. The remote nodes of present invention are ideal hardware devices to get a system component (application) on their devices and then start receiving computation jobs. The guardian nodes are special nodes that are responsible for specific tasks like blockchain validation. The remote node is utilized for AI-ML computations.

The present invention classified Data assets into Datasets and Algorithm. Further granularity is also provided with types of data in datasets and algorithm files/models in the case of an algorithm. The present system categorizes data into general, sensitive, and critical types, enabling finer-grained control and compliance with data protection regulations. The present invention emphasize the optimization of resource utilization by allowing data scientists to utilize idle hardware for computational tasks. This encourages resource efficiency while enhancing the network's computational capacity. It has data asset management, their ownership/allowances along with computation job orchestration by present system, preparing of AI ML models and whole use case around this where prepared model are being used for other computation jobs and prediction.

The present invention, ostrich platform uses the blockchain mechanism to record transactions but these are transaction that the platform has done on behalf of the financial institution in terms of matching the right data to the right algorithm based on pre-defined rules and then send the raw data with an algorithm on a remote node to process the data and generate results which are in-turn sent back to the financial institution. The transactional Data which is pulled from the Clients system can be received in any form as available with the bank/Financial Institution/Client.

### SUMMARY OF INVENTION

The present invention Blockchain-Based Platform for Secure and Distributed AI-ML Computations and Data Asset Management, introduces a revolutionary solution to the challenges surrounding data sharing, collaboration, and computation in the financial sector. In alignment with government data sharing policies, this platform leverages community engagement to foster seamless data sharing and cross-sector collaboration. Key innovations include enabling the harmonious integration of Data Providers and Data Scientists, robust security measures, and unwavering compliance protocols to ensure data integrity, privacy, and regulatory adherence.

The introduction of Remote Nodes, which utilize high-performance hardware for distributed computing tasks, optimizes resource utilization while safeguarding data privacy. Additionally, the present invention mints Non-Fungible Tokens (NFTs) for data assets on blockchain smart contracts, promoting transparency and enabling precise access control.

Key Features of the present invention are as below:
Data Convergence: The platform facilitates the harmonious integration of Data Providers and Data Scientists, allowing data assets and analytical expertise to converge effectively.
Security and Compliance: Stringent security measures and unwavering compliance protocols are implemented to ensure data integrity, privacy, and regulatory adherence.

Remote Nodes: A novel concept of Remote Nodes is introduced, leveraging high-performance hardware for distributed computing tasks, optimizing resource utilization, and safeguarding data privacy.
Data Asset Tokenization: Data assets are tokenized as Non-Fungible Tokens (NFTs) on blockchain smart contracts, ensuring transparency and enabling fine-grained access control.
Smart Contract Infrastructure: The platform incorporates smart contracts, reducing operational costs, enhancing efficiency, and automating contractual agreements.

The incorporation of smart contract infrastructure reduces operational costs, enhances efficiency, and automates contractual agreements. The present invention is a comprehensive solution that benefits financial institutions, data providers, and data scientists engaged in data sharing and computation across various sectors.

### Advantageous Effects of Invention

The main objective of the present invention is to establish transparent and accountable data governance through blockchain technology, ensuring data provenance and minimizing unauthorized manipulations.

Another objective of the present invention is to empower financial institutions and stakeholders with improved data insights, predictive models, and risk management tools to improve decision-making and increase profits.

Yet another objective of the present invention is to create an ecosystem that fosters collaboration, innovation, and knowledge exchange among Data Providers, Data Scientists, and other stakeholders across various sector.

Yet another objective of the present invention is to foster collaboration among diverse entities by providing a platform that encourages knowledge sharing and joint problem-solving.

Yet another objective of the present invention is to implement robust security measures to protect sensitive data and ensure the integrity of data sharing and computation processes.

Yet another objective of the present invention is to unlock the potential of under-utilized high-value datasets by providing a secure environment for AI-ML computations while adhering to legal and compliance requirements.

Yet another objective of the present invention is to use smart contract technology to track the entire process end-to-end, reduce operational costs, and enhance data sharing and collaboration efficiency.

### BRIEF DESCRIPTION OF DRAWINGS

FIG. 1 represents flowchart for tokenization

FIG. 2 represents flowchart for remote jobs

### DESCRIPTION OF EMBODIMENTS

Various aspects of the present invention will be described in detail in connection with the accompanying drawings, in order to provide a better understanding of the present invention. The present invention relates to a blockchain-based platform for secure and distributed AI-ML computations and data asset management. The platform addresses the challenges of suboptimal data sharing mechanisms and inadequate incentivization of collaboration in the financial sector.

The platform' inception resonates seamlessly with the government's strategic vision, encompassing the National Data Sharing, Accessibility Policy, and Data Compliance imperatives. This alignment underscores the compelling necessity and burgeoning demand for innovative solutions that facilitate unfettered data sharing and collaborative endeavors transcending diverse sectors.

Harnessing the power of community engagement in data sharing and collaboration, the present platform becomes a catalyst for the incubation of novel ideas and the ex-peditious attainment of shared objectives. The resultant synergy translates into elevated decision-making prowess and superior outcomes, thereby yielding tangible benefits for not only financial institutions but also the myriad stakeholders involved.

The present invention is the establishment of a platform-cum-protocol expressly designed to bridge the prevailing chasm between Data Providers and Data Scientists.

This integral conduit facilitates the harmonious convergence of data assets and analytical minds, thus enabling the precise formulation of optimal algorithms tailored to specific problem statements. Additionally, the platform introduces the novel concept of remote nodes, strategically positioned to facilitate model preparation and predictive computations. A steadfast commitment to stringent security measures and unwavering compliance protocols remains unwaveringly upheld throughout this intricate web of functionalities.

Platform for Data Scientist: The present invention described herein is a pioneering platform tailored to meet the unique needs of data scientists engaged in the development of machine learning algorithms for problem-specific datasets. Within the realm of data science and machine learning, the platform fills a crucial gap by providing a collaborative, user-friendly environment that empowers data scientists to create, refine, and innovate algorithms effectively.

Traditional tools and platforms often fall short in offering the flexibility, collaboration capabilities, and dataset diversity required for optimal algorithm development. However, this invention represents a paradigm shift in the field. One of its key strengths lies in its ability to integrate a wide variety of datasets, encompassing both structured and unstructured data sources. This diversity allows data scientists to comprehensively understand the complexities associated with real-world problems, leading to more refined and robust algorithms.

Moreover, the platform offers critical features for data visualization, enabling data scientists to explore and interpret datasets effectively. It also provides tools for rigorous model evaluation, comparison, and benchmarking, ensuring that developed algorithms meet industry standards and best practices. To address privacy and security concerns, the platform incorporates robust measures to safeguard sensitive data at every stage of the development process.

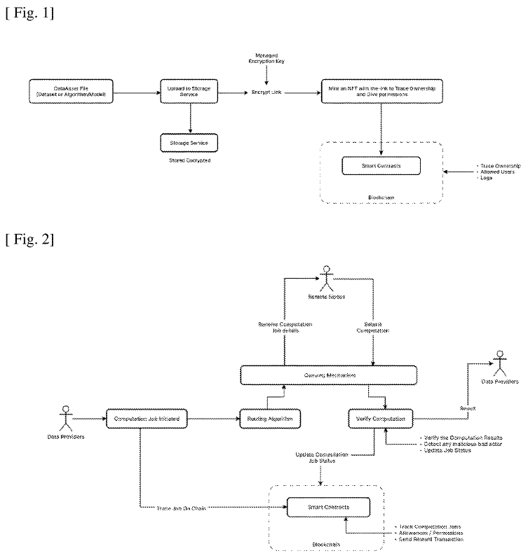

Data Asset Tokenization: The proposed system introduces a comprehensive approach to data asset management. The present invention pertains to a novel system and method that facilitates secure data asset management by integrating blockchain technology and Non-Fungible Tokens (NFTs). This technology enables the seamless and accountable tracking of data assets, consent, and data analytics processes, ensuring security, transparency, and compliance as shown in FIG. 1.

Data Asset Tokenization: Users upload Data Assets onto the system, which are then minted as NFTs on blockchain-based smart contracts. This process guarantees that all actions and consent concerning the data asset are immutably recorded on a distributed ledger. The NFT's unique characteristics enable tracking of asset changes, access logs, and ownership transitions.

Data Asset Ownership and Permission Control: Data Asset Owners have the authority to oversee access to their NFT-based data assets. They can monitor authorized users, view access logs, and revoke access privileges at any given time. This granular control over data access mitigates unauthorized use and ensures compliance with privacy regulations.

Financial Institute Data Sets: Financial Institutes can upload extensive data sets to the system, used for training machine learning models and small/stream of datasets for prediction. These data sets are tokenized as NFTs, ensuring the security of sensitive financial information and enabling transparent audits of data usage.

Algorithm Tokenization: Accomplished Data Scientists who create optimal algorithms for specific problem statements can tokenize their algorithms as Data Assets on the blockchain. This feature enhances the intellectual property rights of the algorithms while fostering collaboration among researchers.

User Contribution and Consumption: Data Asset owners can permit other users to consume and contribute to their data assets. However, before consumption, the system verifies consent recorded on the blockchain to ensure authorized access. This verification process enhances data integrity and protects against unauthorized use.

The system is designed in such a way that whenever any allowed user wants to consume the Data Asset, first, the system will check and verify whether the consent for consumption (as per the data protection act) is granted on blockchain or not by the Financial Information Provider or another authorized person. If consent is given, the Data Asset is shared while recording the transaction on the blockchain.

This end-to-end process ensures accountability, traceability, and compliance.

Remote Nodes: The present platform introduces the concept of Remote Nodes, targeting users with high-performance hardware, computers and laptops. These users can capitalize on their idle resources by participating in distributed computing network as shown in FIG. 2.

Onboarding and Hardware Benchmarking: Remote Nodes are seamlessly on-boarded onto our platform. Their hardware configurations are benchmarked and meticulously recorded. This data serves as the foundation for intelligently assigning computation tasks based on hardware capabilities. The present system dynamically matches compatible computation jobs to specific hardware profiles, ensuring optimal resource utilization.

Flexible Computation Management: Remote Nodes possess full autonomy over their computational engagement. They can initiate computation tasks at their convenience, providing the flexibility to align with their usage patterns. The more computations a remote node undertakes on their hardware, the greater the rewards they accumulate.

This approach incentivizes users to harness their hardware's capabilities and optimize its usage.

Resource Monetization and Rewards: The present platform empowers remote node participants to extract value from their high-performance hardware. By engaging in computation tasks during periods of hardware idleness, users effectively monetize their resources. This arrangement promotes resource efficiency and rewards contributors for their role in our distributed network.

Data Asset Interaction: This access grants them the ability to download essential data for provisioning the computation. After task completion, the data assets are immediately deleted from the remote node's hardware, and their access rights are promptly revoked. This stringent data asset management approach safeguards data privacy and mitigates potential vulnerabilities.

If there is any external interference/malicious behavior from the remote node, the remote node app will lock peripherals to ensure data security.

The present platform's Remote Nodes concept empowers hardware owners to optimize resource utilization and derive benefits from their high-performance devices. By harnessing idle hardware for computation tasks, users contribute to a distributed network while receiving rewards.

Main embodiment of the present invention, a blockchain-based platform to secure and distributed Artificial Intelligence-Machine Learning computations and data asset management comprising of:
a) A blockchain network with a secure consensus mechanism for recording data transactions;
b) Smart contracts with predefined rules to regulate specific actions;
c) A data asset tokenization system that mints Non-Fungible Tokens on the blockchain, creating traceable records for Data Assets;
d) An accountability system utilizing blockchain-based Non-Fungible Tokens to monitor Data Asset ownership, consent, and authoritative actions; and
e) A computation job management module for Data Assets, including assignment to remote nodes and tracking related transactions.

Another embodiment of the present invention, a queuing mechanism for assigning computation jobs to remote nodes based on their hardware capabilities and smart contracts for data governance that track and manage Computation Jobs.

Another embodiment of the present invention, data assets and algorithms are securely transmitted to Remote Node Providers for training and deployment, ensuring data privacy and security.

Another embodiment of the present invention, all computations executed by remote node providers are verified within the system to ensure accuracy and compliance with predefined rules Another embodiment of the present invention, a method to secure Blockchain-Enhanced Data Asset Management and Distributed Computation comprises of:
a) A blockchain network with a secure consensus mechanism for recording data transactions;
b) Smart contracts with predefined rules to regulate specific actions with pre-defined rules;
c) A data asset tokenization system that mints Non-Fungible Tokens on the blockchain, creating traceable records for Data Assets;
d) An accountability system utilizing blockchain-based Non-Fungible Tokens to monitor Data Asset ownership, consent, and authoritative actions;
e) A computation job management module for Data Assets, including assignment to remote nodes based on their hardware capabilities and tracking jobs by using smart contracts for data governance and tracking related transactions;
f) Securely transmitting data assets and algorithms to Remote Node Providers for training and deployment, ensuring data privacy and security; and
g) Verifying all computations performed by remote node providers to ensure accuracy and compliance with predefined rules.

Another embodiment of the present invention, the distributed ledger ensures transparency and accountability of data transactions, allowing for the immutable recording of data provenance and ownership transitions.

Another embodiment of the present invention, the intelligent contract infrastructure automates data-sharing agreements and access controls, reduce operational costs and enhancing process efficiency.

Another embodiment of the present invention, the Remote Node system intelligently matches computation tasks with hardware capabilities, optimizing resource utilization and computational capacity to give rewards to users for their contributions.

### Summing Up the Flow of the Present Invention

Data Set Preparation and Algorithm Minting: Data Providers, particularly financial institutions, play a pivotal role by contributing their valuable Data Sets to present platform and their DataSet are minted as NFT for traceability. Data Scientists gain access to a subset of these Data Sets for crafting innovative solutions to specific problem statements. This process enables the development of machine learning models that can be used to generate revenue and reduce risks.

Algorithms also are similarly minted as an NFT on the blockchain. The minted NFT encapsulates the intellectual property inherent in the Algorithm. This innovative approach endorses intellectual property rights and encourages collaborative solution development.

Computation Job Generation and Remote Nodes: The present platform orchestrates the generation of computation jobs tailored to the problem statements. These computation jobs are mainly for training and deploying Machine Learning (ML) model on remote nodes. These computation jobs encapsulate the Data Set and Algorithm, forming the basis for ML model training. The platform extends its reach and enhances its computational capacity by leveraging remote computation capabilities.

Blockchain-Enhanced Job Tracking and Data Governance: The core strength of our platform lies in its ability to track computation jobs using blockchain technology comprehensively. This enables the immutable recording of each computation job's lifecycle, facilitating transparent and accountable data governance. By providing an auditable trail of job execution, the present platform ensures data provenance and minimizes the potential for unauthorized manipulations.

Resilient Job Allocation in a Distributed Network: In the event that an active remote node experiences downtime or goes offline, the present system demonstrates re-siliency by reallocating failed tasks to another node within the distributed network.

This dynamic job reallocation preserves the integrity of the computation process and maintains seamless functionality across the platform.

Model Verification: An essential aspect of the present platform's integrity is the verification of Machine Learning (ML) models created on remote nodes. To ensure the correctness of training and testing methodologies, The present system rigorously examines these models. Verification procedures contribute to the establishment of reliable and accurate ML models, fostering trust in the computational outcomes.

The present platform converges innovation, collaboration, and technological advancements. By harmonizing Data Providers, Data Scientists, Algorithms, and Remote Nodes, the present invention cultivates an ecosystem that drives sophisticated algorithmic solutions while ensuring the reliability, accountability, and security of computation jobs, data compliance, and data interactions.

Incorporation of the present smart contract infrastructure within the system offers a strategic avenue for the reduction of operational costs through the optimization of efficiency. These smart contracts, functioning as algorithmic agents, facilitate the automated execution of contractual agreements between pertinent entities. This mechanized orchestration expedites transactional processes, concurrently bolstering security protocols without necessitating intermediary intervention. The resultant impact manifests as a substantive diminution in operational expenditures, accompanied by a discernible augmentation in overall operational efficiency. Consequently, Ostrich Solutions materializes as an enticing prospect for financial institutions and a diverse assembly of stakeholders, each motivated by the prospect of streamlined workflows and fiscally prudent practices.

The present invention provides a comprehensive secure data asset management, collaboration, and distributed computation solution. The platform promotes data privacy and data compliance by integrating Blockchain technology in the form of NFTs and efficient resource utilization by integrating powerful consumer hardware for our computation needs. Financial institutions, data providers, and data scientists stand to benefit from this innovative approach to data sharing and computation.

The Major Flow points are also mentioned in the above section (Summing up the Flow)

Data Asset Tokenization: Financial institutions contribute valuable Datasets to the platform. These Datasets are minted as NFTs on the blockchain, ensuring traceability and immutability.

Access for Data Scientists: Data Scientists gain access to curated Datasets, using a subset for crafting innovative algorithms.

Algorithm Tokenization: Successful and best algorithms created by Data Scientists are tokenized as NFTs, endorsing intellectual property rights and encouraging collaboration.

Computation Job Generation: The platform generates computation jobs for ML model preparation, combining Datasets and Algorithms. This Job is generated and traced on blockchain throughout.

Queuing Mechanism and Routing: The present system has a queuing mechanism to send these jobs to remote nodes for computation based on a routing algorithm. This routing is done based on the type of computation job and remote node hardware/capabilities.

Remote Node Allowance: After receiving the computation job, remote nodes indicate a message to the system, and they are granted access to the data assets dynamically. After this, they can download data assets after successful verification and start computing.

Remote Node Computing: Computation tasks are executed on remote nodes, extending computational capacity and efficiency.

Blockchain-Enhanced Job Tracking: The blockchain comprehensively tracks each job's life cycle, ensuring transparency and accountability in data governance.

Resilient Job Allocation: In remote node downtime, tasks are reallocated within the distributed network to maintain uninterrupted computation.

Model Verification: After completing the computation job, remote nodes send the results to the system for verification. Rigorous verification of ML models and predictions ensures the accuracy and reliability of results.

Ecosystem Synergy: The platform harmonizes Data Providers, Data Scientists, Algorithms, and Remote Nodes, fostering innovation, collaboration, and security in computation, data compliance, and interactions.

1. A blockchain-based platform to secure and distributed Artificial Intelligence-Machine Learning computations and data asset management comprising of:
a. a blockchain network with a secure consensus mechanism for recording data transactions;
b. smart contracts with predefined rules to regulate specific actions;
c. a data asset tokenization system that mints non-fungible tokens on the blockchain, creating traceable records for general personal data, critical personal data, and sensitive personal data;
d. an accountability system utilizing blockchain-based non-fungible tokens to monitor data asset ownership, consent, and authoritative actions; and
e. a computation job management module for data assets, including a queuing mechanism for assigning computation jobs to remote nodes based on their hardware capabilities and smart contracts for data governance that track and manage computation jobs.

2. The blockchain-based platform of claim 1, wherein data assets and algorithms are securely transmitted to remote node providers for training and deployment, ensuring data privacy and security.

3. The blockchain-based platform of claim 1, wherein all computations executed by remote node providers are verified within the system to ensure accuracy and compliance with predefined rules.

4. A method to secure Blockchain-Enhanced Data Asset Management and Distributed Computation comprises of:
a. a blockchain network with a secure consensus mechanism for recording data transactions;
b. smart contracts with predefined rules to regulate specific actions with pre-defined rules;
c. a data asset tokenization system that mints non-fungible tokens on the blockchain, creating traceable records for general personal data, critical personal data, and sensitive personal data;
d. an accountability system utilizing blockchain-based non-fungible tokens to monitor data asset ownership, consent, and authoritative actions;
e. a computation job management module for data assets, including assignment to remote nodes based on their hardware capabilities and tracking jobs by using smart contracts for data governance and tracking related transactions;
f. securely transmitting data assets and algorithms to remote node providers for training and deployment, ensuring data privacy and security; and
g. verifying all computations performed by remote node providers to ensure accuracy and compliance with predefined rules.

5. The method to secure Blockchain-Enhanced Data Asset Management and Distributed Computation of claim 4, wherein the distributed ledger ensures transparency and accountability of data transactions, allowing for the immutable recording of data provenance and ownership transitions.

6. The method to secure Blockchain-Enhanced Data Asset Management and Distributed Computation of claim 4, wherein the intelligent contract infrastructure automates data-sharing agreements and access controls, reduce operational costs and enhancing process efficiency.

7. The method to secure Blockchain-Enhanced Data Asset Management and Distributed Computation of claim 4, wherein the Remote Node system intelligently matches computation tasks with hardware capabilities, optimizing resource utilization and computational capacity to give rewards to users for their contributions.
